(19) United States
(12) Patent Application Publication
(10) Pub. No.: US 2006/0293487 A1
(43) Pub. Date: Dec. 28, 2006

(54) POLYURETHANES, POLYURETHANEUREAS AND POLYUREAS AND USE THEREOF

(75) Inventors: Reinoud Jaap GAYMANS, Enschede (NL); Jan M. van der Schuur, Enschede (NL); Bart A.J. Noordover, Eindhoven (NL)

Correspondence Address: BANNER & WITCOFF, LTD., 28 STATE STREET, 28th FLOOR, BOSTON, MA, 02109-9601, US

(73) Assignee: Stichting Dutch Polymer Institute, Eindhoven (NL)

(21) Appl. No.: 11/456,451

(22) Filed: Jul. 10, 2006

Related U.S. Application Data
(63) Continuation of application No. PCT/IB05/00764, filed on Jan. 6, 2005.
(60) Provisional application No. 60/534,915, filed on Jan. 8, 2004.

(51) Int. Cl. C08G 18/00

(52) U.S. Cl. 528/44

(57) ABSTRACT

The present invention is to a chain of polyurethane, polyurethaneurea and/or polyurea segmented copolymer wherein the polyurethane, polyurethaneurea and/or polyurea segments contain a chain extender having an amide segment, an ester segment, or a combination of amide and ester segments.

The invention relates to isocyanate based copolymers and in particular to chain extenders for producing such materials.

Polyurethanes, polyurethaneureas and polyureas (PUU) are elastomeric materials consisting of segment block copolymers composed of hard and soft segments. PUU can generally be formed by the reaction of a polyol, an isocyanate and a chain extender. The hard segment generally consists of the isocyanate and the chain extender and the soft segment is the polyol.

In PUU generally, 1,4-butanediol is used as the chain extender. Other diol chain extenders include ethanediol, diethylene glycol, dipropylene glycol ethylene glycol, and 1,6-hexanediol. In addition diamines like ethylene diamine, propylene diamine, tetramethylene diamine and hexamethylene diamine and amino-alcohols like ethanolamine and hexanolamine can also be used in producing PUU.

It is an object of the present invention to incorporate suitable amide, ester or amide-ester chain extenders in the PUU copolymers. The chain extenders of the present invention produce elastomers which have enhanced melt stability and enhanced hardness and improved elastic behavior. Also the low temperature flexibility is improved and the crystallization is fast which are advantages for processes using these materials as it allows for shortened process time.

The present invention is to a chain extended polyurethane, polyurethaneurea and/or polyurea segmented copolymer wherein the polyurethane, polyurethaneurea or polyurea segment is attached via a urethane or urea linkage to a chain extender having an amide segment, an ester segment or a combination of amide and ester segments as represented by Formula I
—R—B—(R′—B)n-R— Formula (I)
wherein each B represents an —N(H)C(O)—, —C(O)N(H)—, —C(O)—O— or —O—C(O)—moiety;
each R and R′ is independently chosen from the group consisting of alkylene moieties, alicyclic moieties, arylene moieties, alkaryl or arylalkyl moieties, or heterocyclic moieties; and
n has a value of 0 to 6, preferably from 1 to 3.
In another embodiment, the present invention is to a thermoplastic elastomer produced from the copolymers described above.

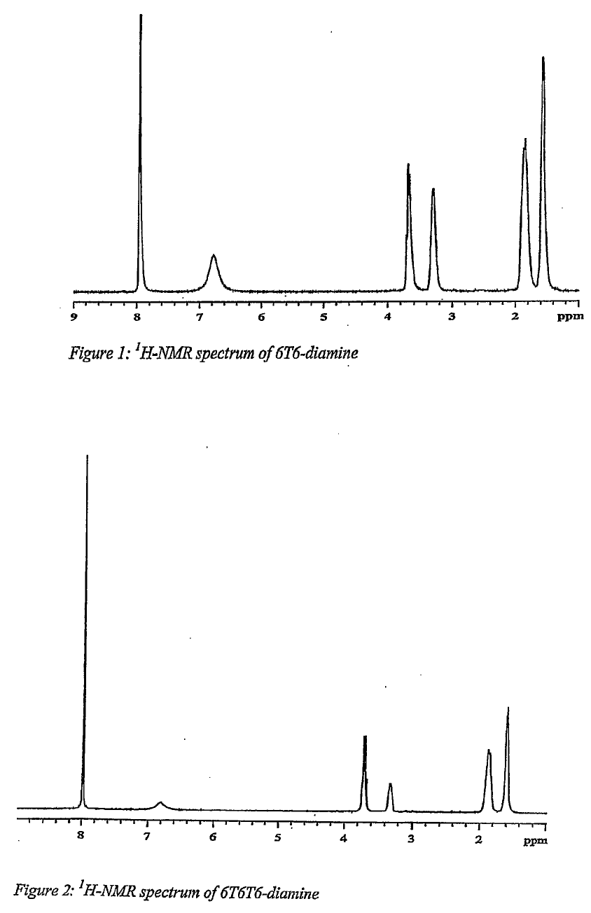

FIG. 1 shows a ¹H-NMR spectrum of the chain extender designated 6T6-diamine prepared from 1,6-diaminohexane and dimethyl terephthalate.

FIG. 2 shows a ¹H-NMR spectrum of the chain extender designated 6T6T6-diamine prepared from diphenyl terephthalate and 1,6-diaminohexane.

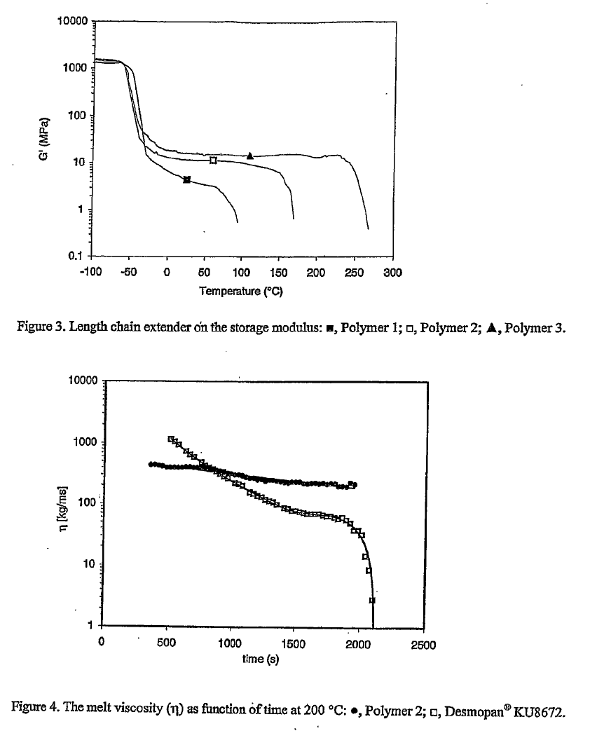

FIG. 3 shows the effect of the length of chain extender on the storage modulus.

FIG. 4 shows the melt viscosity of the 6T6T6 diamine.

The PUU copolymers of the present invention are preferably made from polyol soft segments, isocyanate (NCO) and a chain extender containing amide, ester or a combination of amide and ester linkages. The polyol soft segment and the isocyanete may be prereacted to form an isocyanate terminated prepolymer, which is then reacted with the extender. As compared to copolymers prepared from commonly used chain extenders, such as aliphatic diols and diamines, the copolymers of the present invention are found to be semi-crystalline materials that crystallize fast and have a high modulus. In addition the materials have a low T_{g}, a low-temperature flexibility (low T_{flex}), sharp T_{flow} (melting temperature, Tₘ), a virtually temperature independent modulus in the rubbery plateau regions in combination with excellent elastic properties (low compression set) and a good thermal stability. If the copolymer is a linear or a nearly linear polymer it is most often homogeneous in the molten state and upon cooling, crystallization is rapid. The copolymers of the present invention are further characterized by a well defined uniform soft segment and well defined uniform hard segment. These linear uniform copolymers are therefore homogeneous in a molten state and show clear phase separation upon cooling. These “linear” and uniform PUU are easily melt-processable and reprocessable by extrusion, injection molding, compression molding and fiber spinning.

In a preferred synthesis route, the PUU copolymer is prepared by the reaction between a chain extender containing an NCO-reactive group and an NCO terminated prepolymer. Chain extenders containing such reactive groups can be represented by the formula
X—R—B—(R′—B)ₙ—R—X (II)
wherein each B represents an —N(H)C(O)—, —C(O)N(H)—, —C(O)—O— or —O—C(O)—moiety;
each R and R′ is independently chosen from the group consisting of alkylene moieties, alicyclic moieties, arylene moieties, alkaryl or arylalkyl moieties or heterocyclic moieties;
n has a value of 0 to 6, preferably is from 0 to 3,
and X is an isocyanate reactive group, such as hydroxyl, primary amine or secondary amine. In one preferred embodiment, the chain extender contains at least one amide segment.

Generally at least 50 percent, and preferably at least 70 percent of the —R—B—(R′—B)ₙ—R— segments are uniform in length as measured by ¹H-NMR. In a preferred embodiment the segments are symmetrical, meaning that for n−1, each R is the same and for n=3, each R is the same and each R′ is the same.

Preferred amide extender segments —R—B—(R′—B)ₙ—R— are chosen from the group consisting of
—R—C(O)N(H)—R—
—R—C(O)N(H)—R′—N(H)C(O)—R—
—R—N(H)C(O)—R′—C(O)N(H)—R—
—R—N(H)C(O)—R′—N(H)C(O)—R—

Preferred ester extender segments —R—B—(R′—B)n-R— are chosen from the group consisting of
—R—C(O)O—R—
—R—C(O)O—R′—OC(O)—R—
—R—OC(O)—R′—C(O)O—R—
—R—OC(O)—R′—OC(O)—R—
wherein each R and R′ is independently chosen from the group consisting of alkylene moieties, alicyclic moieties, arylene moieties, alkaryl or arylalkyl moieties, or heterocyclic moieties. More preferably each R and R′ is independently chosen from the group consisting of C1-C20 alkylene moieties, C4-C20 alicyclic moieties, C6-C20 arylene moieties and C7 to C30 alkaiyl moieties. When an alkylene moiety, preferably the alkylene moiety is 2 to 12 carbon atoms, more preferably from 3 to 8 carbon atoms. When an alicyclib moiety, preferably the moiety contains from 4 to 22 carbon atoms and preferably from 4 to 12 carbon atoms. When an arylene moiety, the moiety preferably contains from 6 to 20 carbon atoms, more preferably from 6 to 12 carbon atoms. When an alkaryl or arylaklyl moiety, preferably the moiety contains from 7 to 20 carbon atoms. When a heterocyclic moiety is present, preferably the moiety contains from 6 to 12 atoms in the ring structure. An example of a heterocyclic moiety is piperazine.

Amide extenders useful in the present invention are amide containing compounds which contain two isocyanate reactive groups, generally active-hydrogen groups, such as —OH, primary or secondary amines , —SH and —COOH. The chain extenders for use in the present invention can be prepared during the copolymerization process or prepared first before adding to the polymerization medium. For example, chain extenders containing a diamide can be formed by the reaction of a diacid with an amine, preferably a diamine.

Dicarboxylic acids used are available commercially or can be prepared using known processes in the art. For example, to produce a dicarboxylic acid containing an aromatic ring, the ring can be alkylated via a Friedel-Crafts alkylation followed by oxidation of the alkyl side chains. Examples of commonly commercially available aromatic dicarboxylic acids include dicarboxylic acid isomers of benzene and napthalene. Examples of dicarboxylic acids based on alkyl groups include maleic acid, malonic acid, succinic acid, glutaric acid, adipic acid, suberic acid, sebatic acid and dodecandioc acid.

In a preferred embodiment of the present invention, the chain extenders are formed by the reaction of one or more aromatic dicarboxylic acids with one or more alkyl diamines.

By way of further example, a diamide chain extender (n=1) formed by the reaction of an aryl dicarboxylic acid (dimethyl terephthalate) with a diamine (1,6-diaminohexane) can be represented by the following as described in the literature (J. Krijgsman, D. Husken, R. J. Gaymans, Polymer, 44 (2003), 7043-7053) and WO Publications 91/13930 and 2003/070807:

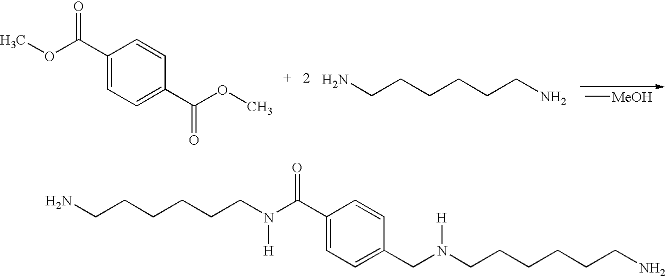

This reaction can be carried out in the bulk or in solution at 50°-150° C. As the resulting diamine product (designated 6T6) crystallizes easily, it is preferably isolated by crystallization, which takes place in the reaction medium as soon as it is formed. On filtration the excess 1,6-diaminohexane is washed out. This diamine extender reacts during the polymerization with an isocyanate group to form a urea group.

A tetra-amide extender (n=3) formed by reaction on an aryl dicarboxylic acid (dimethyl terephthalate) (T) with a diamine (1,6-diaminohexane) (6) can be represented by the following: 2 T-dimethyl+6−>T6T-dimethyl
T6T-dimethyl+6−>6T6T6-diamine

The synthesis of compounds like T6T-dimethyl is described in GB Pat. 1,365,952, 1971 and P. J. M. Serrano, A. C. M. van Bennekom, R. J. Gaymans, Polymer, 39 (1998), 5773-5780). The synthesis of 6T6T6-diamine from T6T-dimethyl can best be carried out in solution. As the 6T6T6-diamine crystallizes easily it is preferably isolated by crystallization, which takes place in the reaction medium as soon as it is formed. On filtration the excess diamine is washed out.

Ester extenders useful in the present invention are ester containing compounds which contain two isocyanate reactive groups, generally active-hydrogen groups, such as —OH, primary or secondary amines, —SH and —COOH. The chain extenders for use in the present invention can be prepared during the copolymerization process or prepared first before adding to the polymerization medium. For example, chain extenders containing a diester are formed by the reaction of a diacid with an alcohol, preferably a diol, via standard procedures in the art. Generally the starting materials are diacids like terephthalic acid or diacid ester like dimethyl terephthalate. The ester compounds can also be obtained by alcoholysis of polyesters.

Examples of commercially available diols based on alkyl groups include ethylene glycol, propylene glycol, butane diol, pentane diol, hexanediol, heptane diol, octane diol, decane diol ans dodecane diol. Cornmercially available aromatic diols include hydroquinone and other benzene and naphthalene diols.

Soft segments useful in the present invention are built from compounds which contain two or more isocyanate reactive groups, generally active-hydrogen groups, such as —OH, primary or secondary amines, —SH and —COOH. Representative of suitable segments are generally known and are described in such publications as High Polymers, Vol. XVI; “Polyurethanes, Chemistry and Technology”, by Saunders and Frisch, Interscience Publishers, New York, Vol. I, pp. 32-42, 44-54 (1962) and Vol II. Pp. 5-6, 198-199 (1964); Organic Polymer Chemistry by K. J. Saunders, Chapman and Hall, London, pp. 323-325 (1973); and Developments in Polyurethanes, Vol. I, J. M. Burst, ed., Applied Science Publishers, pp. 1-76 (1978). Representative of suitable segments include polyester, polylactone, polyether, polyolefin, polycarbonate polyols, and various other segments.

Illustrative of the polyester polyols are the poly(alkylene alkanedioate) glycols that are prepared via a conventional esterification process using a molar excess of an aliphatic glycol with relation to an alkanedioic acid. Illustrative of the glycols that can be employed to prepare the polyesters are ethylene glycol, diethylene glycol, propylene glycol, dipropylene glycol, 1,3-propanediol, 1,4-butanediol and other butanediols, 1,5-pentanediol and other pentane diols, hexanediols, decanediols, and dodecanediols. Preferably the aliphatic glycol contains from 2 to 8 carbon atoms. Illustrative of the dioic acids that may be used to prepare the polyesters are maleic acid, malonic acid, succinic acid, glutaric acid, adipic acid, 2-methyl-1,6-hexanoic acid, pimelic acid, suberic acid, and dodecanedioic acids. Preferably the alkanedioic acids contain from 4 to 12 carbon atoms. Illustrative of the polyester polyols are poly(hexanediol adipate), poly(butylene glycol adipate), poly(ethylene glycol adipate), poly(diethylene glycol adipate), poly(hexanediol oxalate), and poly(ethylene glycol sebecate).

Polylactone polyols useful in the practice of this invention are the di-or tri- or tetra-hydroxyl in nature. Such polyol are prepared by the reaction of a lactone monomer; illustrative of which is δ-valerolactone, ε-caprolactone, ε-methyl-ε-caprolactone, and ξ-enantholactone, is reacted with an initiator that has active hydrogen-containing groups; illustrative of which is ethylene glycol, diethylene glycol, propanediols, 1,4-butanediol, 1,6-hexanediol, and trimethylolpropane. The production of such polyols is known in the art; see, for example, U.S. Pat. Nos. 3,169,945, 3,248,417, 3,021,309 to 3,021,317. The preferred lactone polyols are the di-, tri-, and tetra-hydroxyl functional ε-caprolactone polyols known as polycaprolactone polyols.

The polyether polyols include those obtained by the alkoxylation of suitable starting molecules with an alkylene oxide, such as ethylene, propylene, butylene oxide, or a mixture thereof. Examples of initiator molecules include water, ammonia, aniline or polyhydric alcohols such as dihyric alcohols having a molecular weight of 62-399, especially the alkane polyols such as ethylene glycol, propylene glycol, hexamethylene diol, glycerol, trimethylol propane or trimethylol ethane, or the low molecular weight alcohols containing ether groups such as diethylene glycol, triethylene glycol, dipropylene glyol or tripropylene glycol. Other commonly used initiators include pentaerythritol, xylitol, arabitol, sorbitol and mannitol. Preferably a poly(propylene oxide) polyols include poly(oxypropylene-oxyethylene) polyols is used. Preferably the oxyethylene content should comprise less than about 40 weight percent of the total and preferably less than about 25 weight percent of the total weight of the polyol. The ethylene oxide can be incorporated in any manner along the polymer chain, which stated another way means that the ethylene oxide can be incorporated either in internal blocks, as terminal blocks, may be randomly distributed along the polymer chain, or may be randomly distributed in a terminal oxyethylene-oxypropylene block. These polyols are conventional materials prepared by conventional methods.

Other polyether polyols include the poly(tetramethylene oxide) polyols, also known as poly(oxytetramethylene) glycol, that are commercially available as diols. These polyols are prepared from the cationic ring-opening of tetrahydrofuran and termination with water as described in Dreyfuss, P. and M. P. Dreyfuss, Adv. Chem. Series, 91, 335 (1969).

Polycarbonate containing hydroxy groups include those kown per se such as the products obtained from the reaction of diols such as propanediol-(1,3), butanediols-(1,4) and/or hexanediol-(1,6), diethylene glycol, triethylene glycol or tetraethylene glycol with diarylcarbonates, for example diphenylcarbonate or phosgene.

Illustrative of the various other polyols suitable for use in this invention are the styrene/allyl alcohol copolymers; alkoxylated adducts of dimethylol dicyclopentadiene; vinyl chloride/vinyl acetate/vinyl alcohol copolymers; vinyl chloride/vinyl acetate/hydroxypropyl acrylate copolymers, copolymers of 2-hydroxyethylacrylate, ethyl acrylate, and/or butyl acrylate or 2-ethylhexyl acrylate; copolymers of hydroxypropyl acrylate, ethyl acrylate, and/or butyl acrylate or 2-ethylhexylacrylate.

Generally for use in the present invention, the hydroxyl terminated polyol has a number average molecular weight of 200 to 10,000. Preferably the polyol has a molecular weight of from 300 to 7,500. More preferably the polyol has a number average molecular weight of from 400 to 5,000. Based on the initiator for producing the polyol, the polyol will have a functionality of from 1.5 to 8. Preferably the polyol has a functionality of 2 to 3 and more preferably a measured functionality of 1.9 to 2.5. Most preferred are polyols having a theoretical functionality of 2. Having a functionality of near 2 is important for obtaining high molecular weight and the linear character of the resulting PUU copolymer. Although not preferred, blends of polyols may be used especially for those polyols which have individually a theoretical functionality of 2. Preferably the polyol used with the chain extenders of the present invention have a polydispersity of less than 1.2, and more preferable 1.10 or less. The polydispersity of the polymer or polymer blend is defined as the ratio of Mw/Mn where Mw is the weight average molecular weight and Mn is the number average molecular weight. Preferably the unsaturation level of the polyol is below 0.020, more preferably below 0.015 and even more preferably below 0.010 meq unsaturation/gram of polyol.

Also suitable as soft segments are flexible chain segments as mentioned above that are amine terminated and or acid terminated, like the Jeffamine® polyoxyalkyleneamines (Jeffamine is a trademark of Huntsman Chemicals).

The isocyanates which can be used are polyfunctional isocyanates well known to those skilled in the art. Suitable polyisocyanates include aliphatic, cycloaliphatic and aromatic polyfunctional, particularly bifunctional, isocyanates.

Examples of suitable aromatic isocyanates include the 4,4′-, 2,4′ and 2,2′-isomers of diphenylmethane diisocyante (MDI), blends thereof and polymeric and monomeric MDI blends toluene-2,4- and 2,6-diisocyanates (TDI), m- and p-phenylenediisocyanate, chlorophenylene-2,4-diisocyanate, diphenylene-4,4′-diisocyanate, 4,4′-diisocyanate-3,3′-dimehtyldiphenyl, 3-methyldiphenyl-methane-4,4′-diisocyanate and diphenyletherdiisocyanate and 2,4,6-triisocyanatotoluene, 1,5-napthalene diisocyanate and 2,4,4′-triisocyanatodiphenylether.

Aliphatic or cycloaliphatic polyisocyanates having between 2 and 18 carbon atoms, preferably between 4 and 12 carbon atoms can be used. Examples include ethylene diisocyanate, 1,4-tetramethylene diisocyanate, 1,6-hexamethylene diisocyanate, 1,12-dodecane diisocyanate, isophorone diisocyanate, cyclohexane 1,4-diisocyanate, cyclohexane 1,3-diisocyanate, 4,4′-dicyclohexyhmethane diisocyanate, 1-isocyanato-3,3,5-trimethyl-5-isocyanatomethylcyclohexane; 2,4- and 2,6-hexahydrotoluene diisocyanate, 4,4′- and 2,4′-diisocyanatodicyclohexylmethane, saturated analogues of the above mentioned aromatic isocyanates.

Mixtures of isocyanates may be used, such as the conm

mercially available mixtures of 2,4- and 2,6-isomers of toluene diisocyanates. A crude polyisocyanate may also be used in the practice of this invention, such as crude toluene diisocyanate obtained by the phosgenation of a mixture of toluene diamine or the crude diphenylmethane diisocyanate obtained by the phosgenation of crude methylene diphenylamine. TDI/MDI blends may also be used. Mixtures of the various aliphatic, cycloaliphatic and/or aromatic isocyanates may also be used. In a preferred embodiment, the isocyanate is one or more isomers of TDI.

The isocyanate-terminated prepolymer is generally prepared by the reaction of an excess of polyisocyanate with the polyol under standard conditions known in the art. The polyisocyanate is present at an excess to provide an NCO:OH ratio of greater than 2:1 to 20:1. Preferably the NCO:OH ratio is 2.5:1 to 10:1. Most preferably ratio is 3.2:1 to 8:1 The unreacted isocyanate monomer is removed from the prepolymer by distillation or other treatment to a concentration of less than 3 percent, preferably less than 1 percent, more preferably less than 0.5 percent, and yet more preferably less than 0.1 percent by weight of unreacted polyisocyanate in the prepolymer. The temperatures for affecting reaction between the polyisocyanate and polyol are generally up to 120° C.

To facilitate the formation of the urethane bond between the isocyanate and polyol, a catalyst may be used. Such catalysts are known in the art and include tertiary amine compounds, amines with isocyanate reactive groups and organmetallic compounds.

Alternatively the polyol can be added to the polyisocyanate at a controlled rate, as known in art, such as disclosed in WO 96/34904, to produce prepolymers having a low residual free isocyanate monomer.

The prepolymer compositions generally contain from 0.1 to 20, more preferably 0.2 to 15 and more preferably from 0.3 to 10 and most preferably from 0.4 to 8 weight percent unreacted NCO. In some applications, it may be applicable to have from 1 up to 2 percent unreacted NCO,

The amount of hard segment in the polymer can be varied in the range 3 to 60 wt percent, preferably 5 to 50 wt percent according the performance criteria required by the specific polymer application.

The copolymers obtained differ in their properties according to the chemical composition selected and the content of the hard segment. Thus, it is possible to obtain soft, tacky compositions, thermoplastic and elastomeric products varying in hardness up to glasshard duroplasts. The hydrophilicity of the products may also vary within certain limits. The elastic products may be thermoplastically processed at elevated temperatures, for example at 100 to 280° C., providing they are not chemically crosslinked.

The use of the chain extenders according to the invention results in products having an increased hard segment length and an increase in the hard segment density and as a result both the modulus and the elasticity increases. Also the modulus higher is less temperature dependant and low temperature flexibility improved. With the use of amide, esteramide or ester extenders the hard segment concentration and the segment length can be increased without having processing problems like too high melting temperatures.

The PUU copolymers can be made by reacting in a “one-shot” process a polyol, an polyisocyanate, preferably a diisocyanate, and the chain-extender of Formula 1 where the equivalent ratio of NCO groups on the isocyanate to active hydrogen groups on the polyol plus the chain extender is between 1:0.7 and 1:1:3, preferably between 1:0.9 and 0.9:1 and the molar ratio of the chain extender to polyol is between 0.15:1 and 75:1.

In another embodiment, the PUU copolymer is made by reaction an isocyanate-terminated prepolymer with a chain extender of Formula II, the isocyanate terminated prepolymer being the reaction product of a polyisocyanate and a polyol, where the equivalent ratio of NCO groups on the isocyanate to active hydrogen groups on the polyol plus the chain extender is between 1:0.7 and 1:1:3, preferably between 1:0.9 and 0.9:1 and the molar ratio of the chain extender to polyol is between 0.15:1 and 75:1.

The PUU copolymers may be prepared in the bulk or in solution. A process that starts with a solvent, which solvent is stripped as the reaction progresses is a very controlled way to obtain high molecular weight polymers. A bulk process can be in the melt at elevated temperatures and as the reaction rates are high a reactive extrusion process seems very suitable for these materials. The mixing of the reactants can be carried out at ambient temperature and the resulting mixture is then heated to a temperature of the order 40° C. to 130° C., preferably to a temperature of 90° C. to 120° C. Alternatively, one or more of the reactants is preheated to a temperature within the above ranges before the admixing is carried out.

For producing elastomers, the isocyanate index, defined as the number of equivalents of NCO groups in the prepolymer divided by the total number of isocyanate reactive hydrogen atom equivalents in the extender multiplied by 100, ranges from 75 to 140, and preferably from 85 to 120.

The PUU copolymers may optionally contain UV stabilizers, auxiliary substances and additives. Examples include lubricants, such as fatty acid esters and the metal soaps thereof, fatty acid amides and silicone compounds, antiblocking agents, inhibitors, stabilizers to protect against heat and discoloration, flame retardant, dyes, pigments, inorganic and organic filers and reinforcing agents or plasticizers and foaming agents.

Plasticizers include esters of polybasic carboxylic acids with monohydric alcohols. Polymeric plasticizers, such as polyesters of adipic acid, sebacid acid or phthalic acid can also be used. Petroleum-based hydrocarbon distillates, phenol alkylsufonates and phenyl paraffin sulfonates are other examples of plasticizers.

The copolymers of the present invention may be used to produce fibers, adhesives, moldings, in particular to produce extrudates, for example films, and injection molded articles. Moreover, the copolymers may be used as sinterable powder for producing moldings in the form of sheets and hollow articles. Futhermore, elastomers are used in a variety of applications including formation of shaped articles subjected to severe mechanical stresses, such as tires, rollers and cone belts, wheels for industrial or for recreational goods, elastomers for footwear applications and tooling compounds. The copolymers are also suitable for closed cell and open cell foamed products like mattresses, cushions, car seats. These cellular products might be obtained by during polymerization or after polymerization by extrusion foaming.

The following examples are provided to illustrate the present invention. The examples are not intended to limit the scope of the present invention and should not be so interpreted. All percentages are by weight unless otherwise noted.

### EXAMPLES

Prepolymers

PP1 is a TDI terminated prepolymer based on a diol having a molecular weight of approximately 1010, obtained from The Dow Chemical Company as VORASTAR™ B1505. The TDI used is a mixture of 2,4- and 2,6-TDI.

PP2 is a TDI terminated prepolymer based on a diol having a molecular weight of 2000, obtained from Aldrich and the TDI is 2,4-TDI

PP3 is a TDI terminated prepolymer based on the diol ACCLAIM™ 4220N polyol obtained from Bayer AG. ACCLAIM is a trademark of Bayer. The prepolymer is prepared by adding 5.26 g (0.030 moles) of 2,4-TDI to a 250 ml stainless steel reactor and the reactor temperature is brought 40° C. The polyol, (57.97 g, 0.015 moles) is added dropwise while stirring to ensure an excess of TDI at all times. After addition, the reaction is continued for four hours.

PP4 is a TDI terminated prepolymer based on a poly(tetramethylene oxide) with diol-endgroups having a molecular weight of approximately 1500, obtained from Crompton Corp., LF-900A.

PP5 is a MDI terminated prepolymer based on a poly(tetramethylene oxide) with diol-endgroups having a molecular weight of approximately 2000, obtained from Crompton Corp., LFM300.

PP6 is a (hexamethylenediisocyanate) HDI terminated prepolymer based on a poly(tetramethylene oxide) with diol-endgroups having a molecular weight of approximately 1500-2000, obtained from Crompton Corp., LFH520/580.

PP7 is a (hexamethylenediisocyanate) HDI terminated prepolymer based on a poly(tetramethylene oxide) with diol end groups having a molecular weight of approximately 1000-1500, obtained from Crompton Corp.

For the nomenclature of the hard segment in the Examples, R′ of Formulas I and II is designated A for an adipatic group and T for a terephthalic group. The number is the number of carbon atoms in the R group in Formulas I and II.

Synthesis of 6T6-Diamine Chain Extender

A chain extender designated 6T6-diamine is prepared by the reaction of 1,6-diaminohexane and dimethyl terephthalate. In a 1-liter round bottom flask, fitted with a reflux condenser, nitrogen inlet and thermocouple, is added 278.1 g (2.39 moles) of 1,6-diaminohexane and 46.5 g (0.24 moles) of dimethyl terephthalate. The reaction is allowed to proceed for 8 hours at 80° C. The formed white solid is washed in 2 liters of hot toluene (80° C.) and filtered (glass filter, pore size 3). The wash procedure is repeated two times. Recrystallization of the product, designated 6T6-diamine was recrystallized in butyl acetate (20 g/1.5 liters) and found to have a molecular weight of 362.52 gmol⁻¹. The final product is dried in vacuo before use. The product yield is 15.04 g, the melting is temperature 178° C. and the heat of fusion 130 J/g. The NMR spectrum of this compound is given in FIG. 1. The uniformity of this compound was quantified by content of methylene units next to the amine (at: 3.25 ppm) amide (at 3.63 ppm), [3.25 ppm]/[3.63 ppm]. The uniformity is found to be >98 percent.

The uniformity of the 6T6 product is determined by 1H-NMR from the methylene protons at the amide side at 3.69 ppm and methylene protons at amine side at 3.31 ppm. The ratio (R) [methylene amide side at 3.69 /methylene amine side at 3.31] (R3.69/3.3 1) is 1.0 for 6T6 and 2.0 for 6T6T6. The uniformity is approximated by [2-(R3.69/3.31)×100 percent].

Synthesis of 6T6T6-Diamine Chain Extender

A chain extender designated 6T6T6-diamine is prepared from diphenyl terephthalate (DPT) and 1,6-diaminohexane. The DPT is prepared by adding 180 g terephthaloyl dichloride (0.9 moles) to 171.51 g (1.82 moles) of molten phenol (65° C.) The mixture is then heated to 95° C. and the reaction is allowed to proceed for one hour. The mixture forms a white solid. Subsequently the mixture is washed with deionized water and then with hot ethanol (70° C.). The product is dried and is found to have a molecular weight of 193.2 and calculated to be 95 percent pure based on ¹H-NMR analysis. The product is dried in vacuo prior to use.

The DPT (96.25 g, 0.30 moles) is dissolved in 250 ml of m-xylene and 25 ml of dimethyl formamide at 120° C. over a period of 30 minutes. Subsequently, 1,6-diaminohexane (6.0 g, 0.05 moles) dissolved in 50 ml of m-xylene is added to the DPT-solution. The components are allowed to react overnight at 120° C. The formed solid white precipitated, is designated T6T-diphenyl (MW 564.64 gmol-1) and is washed in m-xylene at 120° C.

The second step of synthesis consisted of a reaction between T6T-diphenyl and 1,6-diaminohexante. T6T-diphenyl (22.57 g, 0.04 moles) and 1,6-diaminohexane (93.0 g, 0.80 moles) are weighed in a reactor as described in Example 1. To this mixtures is added 350 ml of N-methyl-2-pyrrolidinone (NMP). The temperature of the reaction is increased to 140° C. to dissolve the T6T-diphenyl, after which the reaction was carried out at 120° C. overnight. A white product designated 6T6T6-diamine is formed, having a M.W. of 608.83 gmol⁻¹. The material is washed in chloroform at 50° C. . The NMR spectrum of this compound is given in FIG. 2.The uniformity of this compound was quantified by content of methylene units next. to the amine (at: 3.25 ppm) amide (at 3.63 ppm), [3.25 ppm]/2*[3.63 ppm]. The uniformity is found to be 96 percent.

Synthesis of Diamine-diamides: 3A3, 4A4, 6A6, 12A12 Chain Extenders

A chain extender designated 3A3-diamine-diamide, 4A4-diamine-diamide, 6A6-diamine-diamide and 12A12-diamine-diamide are prepared by the reaction of 1,3-propandiamine, 1,4-butanediamine, 1,6-hexanediamine or 1,12-dodecanediamine respectively with dimethyl adipate. The synthesis of the 6A6-diamine segment is carried out as follows. To a round bottom flask with flat flange, a reflux condenser with a calcium chloride tube, magnetic stirrer, nitrogen inlet and thermocouple is added 500 gram 1,6-diaminohexane (4,30 mol) and 54 gram dimethyl adipate (0,3 mol). As catalyst 3 ml 0,5 M Natrium methanolate oxide is added (0,5 mol percent). The reaction is carried out at 75° C. for 6 hours.

The extender was washed with diethylether to remove the excess of diamine. Recrystallisation is necessary in order to purify the extenders and this is done according to;
Butyl acetate (15 g /1,5 lt.) is used for the recrystallisation of 3A3 and 4A4
Dioxane (15g /1,5 lt.) is forthe recrystallisation of 6A6 and 12A12

The other extenders were synthesized as per the procedure for the 6A6 prepolymer.

All the products are dried in vacuo before use. The yield, melting temperature and heat fusion for the 4A4 dinaine diaminde and 6A6 diamine-diamide are given in the following table.

| | Yield (percent) | Tm (° C.) | ΔH (J/g) |
|---|---|---|---|
| 4A4-diamine-diamide | 40 | 150 | 80 |
| 6A6-diamine-diamide | 63 | 135 | 67 |

Synthesis of Diol-diamide 3A3, 3T3 Chain Extenders

A chain extender designated 3T3-diol-diamine is prepared by reaction of 3-aminopropanol with dimethyl terephthalate. In a 500 ml round bottom flask with flat flange, a reflux condenser with a calcium chloride tube, magnetic stirrer, nitrogen inlet and thermocouple, is added 100 g (1,3 mol) 3-aminopropanol and 22 g dimethyl terephthalate (0,11 mol). The reaction is allowed to proceed for 16 hours at 120° C. After cooling the reaction product is precipitated in chloroform and filtered. The product was washed several times with diethylether. 3A3-diol-diamide was made in a similar way.

Synthesis of Diol-diester 3T3, 4T4, 6T6 Chain Extenders

Chain extenders designated 3T3-diol-diester, 4T4-diol-diester or 6T6-diol-diester are prepared by the reaction of a 1,3-propandiol, 1,4-butanediol or 1,6 hexanediol respectively with dimethyl terephthalate. For the synthesis of the 6T6-diol-diester hard, to a 1-liter round bottom flask with flat flange, a reflux condenser with a calcium chloride tube, magnetic stirrer, nitrogen inlet and thermocouple, is added 236 g (2,0 mol) 1,6-hexanediol and 39 g dimethyl terephthalate (0,2 mol). As catalyst titanium tetrabutoxide (0,08 g) is added. The reaction is allowed to proceed for 5 hours at 175° C. The 4T4- and 6T6 diol-diesters were prepared in a similar manner.

The diol diesester extenders are recrystallized in water.

Chain Extension of Prepnolymers

Reaction with 6T6-diamine:

To a 250 ml stainless steel reactor, which is constantly flushed with nitrogen, is added 23.23 grams of 2,4-TDI terminated PP2, after which is added 3.66 g of 6T6-diamine. This is followed by the addition of Irganox 1330 (antioxidant obtained from Ciba Specialty Chemicals) at a level of 1 percent wt of the prepolymer and 80 ml of anhydrous N,N-dimethylacetamide. The reaction is carried out at 120° C. for 5 hours with mixing. Upon completion, the solvent is stripped in vacuo (pressure <0.4 mbar) at 120° C. After cooling the tough transparent polymer is granulated.

The above procedure is used for chain extension with other chain extenders, with adjustment of the amount of chain extender and/or prepolymer to added to maintain approximately a 1:1 molar ratio of NCO groups of the prepolymer to NCO reactive groups on the chain extender.

Sample Preparation

Injection Moulding

Polymers with flow temperatures in the appropriate range (up to 190° C.) are injection moulded using a small-scale (10-30 g.) manually operated injection moulding machine (Arburg H). The obtained samples (70×9×2 mm) are used for Dynamical Mechanical Analysis (DMA) and compression set experiments.

Compression Moulding

Segmented polyurethanes that did not flow below 200° C. are processed through compression moulding. Approximately 2.5 g. of polymer is cut into small pieces and dried overnight. The material is spread uniformly into a bar-shaped mould (8×1.8×0.2 cm), which is placed between two preheated metal press plates. Prior to pressing, air is removed from the polymer in the mould by dumping (that is quickly pressurising the sample, followed by depressurising). This procedure is repeated four times. A Lauffer 40 press is used to press the samples at 10 Mp (˜8.5 MPa) at 20° C. This temperature is maintained for 3 minutes, after which time the sample is left to cool under pressure. The resulting test bars are cut from the mould and used for characterization purposes.

Property Measurements

Viscometry

Viscosity determinations are carried out with a capillary Ubbelohde (type 0C) at 25° C., using a polymer solution with a concentration of 0.1 g/dl in dimethyl acetamide (DMAc).

Compression Set

Samples for the compression determinations are cut from injection moulded bars and. dried before use. A compression of 25 percent is applied for 24 hours by placing the samples between two metal plates at room temperature (ASTM 395 B standard). Half an hour after the load is released, sample thickness is determined. The compression set is determined as:

$$Compression set = \frac{{ⅆ}_{0} - {ⅆ}_{2}}{{ⅆ}_{0} - {ⅆ}_{1}} \times 100 \% [ percent ]$$

with: d0=sample thickness before compression [mm]
d1=sample thickness during compression [mm]
d2=sample thickness after compression [mm]
   Dynamical Mechanical Analysis (DMA)

Torsion behavior of polymer samples, prepared by means of injection moulding and dried before use, are studied at a frequency of 1 Hz. A Myrenne ATM3 torsion pendulum is used, at 0,1 percent strain and a heating rate of 1° C. / min. Storage modulus G′ and loss modulus G″ are measured as a function of temperature, starting at −100° C. The glass transition temperature (T_{g}) are determined as the maximum of the loss modulus curve. The flow temperature (T_{fl}) of the sample are defined as the temperature at which the storage modulus reached a value of 1 MPa (or 0.5 MPa for soft materials). The shear modulus of a polymer sample was determined as the value for the storage modulus at 25° C.

In addition, this measurement provides information concerning the temperature range within which the polymer is applicable. The rubber plateau should be temperature independent (that is horizontal), which means that the modulus of the elastomer remains constant. The temperature at which the rubber plateau begins is referred to as the flex temperature T_{flex}.

Melt Viscosity

The melt viscosity of polymer samples is determined in time at constant melt temperature and piston speed, using a capillary flow rheometer. The rheometer determines the force necessary to push the polymer melt through a capillary. From this force, the melt viscosity can be calculated using the following equation.

$$η = \frac{F \cdot {r}_{c}^{4}}{8 \cdot π \cdot {R}_{mc}^{4} \cdot {L}_{c} \cdot S} [ Pa s ]$$

with: F=force on piston [N]=[Pa²]
r_{c}=inner radius of the capillary [m]
R_{mc}=inner radius of the melt chamber [m]
L_{c}=length of the capillary [m]
S=piston speed [ms ⁻¹]
The time dependence of the melt viscosity at a certain temperature gives an indication of the degradation behavior of the material.

### Examnles 1-3

Examples 1-3 are PUU copolymers based on 2,4-TDI-propolymers containing a 2000 MW diol (PP2). The properties of the elastomers are given in Table 1.

TABLE 1
Properties of elastomers from 2,4-TDI-prepolymers based
on 2000 MW diol at varying hard segment lengths.

| Sample | MW | HS | HS [wt percent] | T_{g} | T_{flex} | T_{flow} | G′ at 25° C. | CS | ηᵢₙₕ |
|---|---|---|---|---|---|---|---|---|---|
| Number | (a) | (b) | (c) | [° C.] | [° C.] | [° C.] | [MPa] | [percent] | [dl/g] |
| 1C(*) | 2000 | 6 | 19.3 | −51 | −25 | 103 | 4.35 | 14.9 | 0.58 |
| 1 | 2000 | 6T6 | 26.7 | −53 | −34 | 168 | 12.6 | 10.1 | 0.58 |
| 2 | 2000 | 6T6T6 | 32.9 | −55 | −29 | 264 | 16.1 | 6.2 | 0.35 |
| 3C(*) | 2000 | 3 | 17.8 | −54 | −30 | 88 | 4.4 | 17.8 | 0.37 |
| 3 | 2000 | 3T3 | 24.3 | −54 | −34 | 129 | 7.4 | 33.4 | 0.35 |

(a) Molecular weight of the poly(propylene oxide) polyol.
(b) hard segment characterized as mTm, where m = number of carbon atoms in diamine, T = teraphthalic moiety
(c) hard segment [wt percent] calculated from diamine hard segment + toluene diisocyanate groups on either side of diamine HS
d) Tm as measured by DSC at a heating rate of 20o C./min
(*)not an example of this invention

Table 1 shows that with increasing extender length, the T_{g} and T_{flex} temperatures decrease, meaning a better low temperature flexibility for the amide extended polymers. Also with increasing extender length the modulus (G′) increases to values much higher than those obtainable with hard segments known in the art, such as hexane diamine (ex. 1 C) and surprisingly at the same time the compression set values decreased. The flow temperature (T_{flow}) increased strongly too.

DMA experiments are carried out on polymers derived from PP1. FIG. 3 shows the storage modulus curves. In general, the graphs show a sharp and low Tg. Materials with diamide extender 6T6, have a relatively temperature independent rubber plateau. These characteristics indicate that these polymers are highly phase separated. FIG. 3 also shows that the polymer has a sharp drop in G′ at its Tg.

The results also show that by extending the hard segment length, the rubbery plateau becomes much more temperature independent and Tfl

(w increases with 60-70° C. The results given in Table 1 and FIG. 3 show the shear modulus (defined as the value for G′ at 25° C.) increases when hard segments containing amide linkages are introduced.

The melt stability of Polymer 2 (Example 2) was studied by measuring the melt viscosity as function of time at 200° C. and a shear rate of 57.5s⁻¹ (FIG. 4). For comparison also an industrial TPU is measured. As can be seen Polymer 2 has compared to the industrial TPE an improved thermal stability, this is important for the melt synthesis and melt processability.

### Examples 4-6.

The effect of hard segment concentration at increasing soft segment length is displayed by the results given in Table 2.

TABLE 2
properties of elastomers from TDI-prepolymers, based
on 1000 (PP1), 2000 (PP2) and 3900 MW diols (PP3).

| | MW | HS | HS [wt percent] | T_{g} | T_{flex} | T_{fl} | G′ at 25° C. | CS | ηᵢₙₕ [dl/g] |
|---|---|---|---|---|---|---|---|---|---|
| # ex. | PPO | (b) | (c) | [° C.] | [° C.] | [° C.] | [MPa] | [percent] | (d) |
| 4C(*) | 1000 | 6 | 30.7 | −20 | 34 | 84 | 8.0 | 64.3 | 0.54 |
| 5C(*) | 2000 | 6 | 19.3 | −53 | −30 | 103 | 5.2 | 14.9 | 0.58 |
| 6C(*) | 3900 | 6 | 10.8 | — | — | — | — | — | 0.24 |
| 4 | 1000 | 6T6 | 40.4 | −35 | 50 | 158 | 48.0 | 48.0 | 0.41 |
| 5 | 2000 | 6T6 | 26.7 | −55 | −34 | 168 | 12.8 | 10.1 | 0.58 |
| 6 | 3900 | 6T6 | 15.6 | −68 | −46 | 132 | 2.6 | 14.1 | 0.23 |

(b) 6 represents chain extension with 1,6-diaminohexane

Table 2 shows the influence of extender segment length at different soft segment length. Increasing the extender segment length increases the modulus strongly with a decreases of the T_{g} and a decreasing compression set. At the same time the flow temperatures increase.

### Examples 7-9

Example 7-9 are PUU copolymers based on the prepolymers PP4, PP5 and PP6 ended with the 6A6-diamine-diamide. The properties of the resulting products are given able 3.

TABLE 3
Properties of polyurethaneureas with
6A6 diamine-diamide extender

| | | Mw ether | HS | T_{g} | T_{flex} | G′_{25° C.} | T_{flow} |
|---|---|---|---|---|---|---|---|
| | Prepolymer | (g/mol) | (percent) | (° C.) | (° C.) | (MPa) | (° C.) |
| 7 | PP4/TDI | 1886 | 35.5 | −72 | 5 | 15 | 165 |
| 8 | PP5/MDI | 2209 | 37.8 | −63 | 15 | 15 | 205 |
| 9 | PP6/HDI | 2000 | 33.7 | −69 | 15 | 30 | 225 |

Table 3. shows the influence of diisocyanate on the mechanical and thermal prperties. The polymers based on HDI-diisocyanate were found to have a higher G′ moldulus.

Examples 10-18 are PUU copolymers based on the prepolymers PP7 and different nders. Examplel 9C is a control based on 1,3-propanediol. The properties of the resulting polyurethaneureas are given in Table 4.

TABLE 4
Properties of copolymers based on PP7
with HDI, PTMO length 1300 g/mol

| | | HS | T_{g} | T_{flex} | G′_{25° C.} | T_{flow} |
|---|---|---|---|---|---|---|
| | Extender | (percent) | (° C.) | (° C.) | (MPa) | (° C.) |
| 10 | 3A3-diamine-diamide | 42.3 | −67 | −10 | 20 | 160 |
| 11 | 4A4-diamine-diamide | 43 | −63 | 0 | 50 | 240 |
| 12 | 6A6-diamine-diamide | 44.4 | −65 | −5 | 50 | 230 |
| 13 | 12A12-diamine- | 48.2 | −65 | −10 | 50 | 195 |
| | diamide | | | | | |
| 14 | 3A3-diol-diamide | 43 | −65 | −15 | 35 | 140 |
| 15 | 3T3-diol-diamide | 42.9 | −66 | −10 | 55 | 160 |
| 16 | 3T3-diol-diester | 42.9 | −65 | −35 | 40 | 100 |
| 17 | 4T4-diol-diester | 43.6 | −66 | −35 | 30 | 95 |
| 18 | 6T6-diol-diester | 45 | −67 | −40 | 25 | 80 |
| 19C | 1,3-propanediol | 37 | −66 | 10 | 25 | 90 |

Table 4 shows the influence of the type of extender on mechanical and thermal properties. For the diamine-diamide extender the highest moduli could be obtained with even number of methylene units. For the diol-diamide and diol-diester the odd number of methylene units in the amino alcohol and diol give the highest moduli. These moduli are also higher than the comparative sample 19 with 1,3-propanediol. Another observed effect is the extenders with a terephthalic group (T) have higher moduli and Tflows compared to an adipic acid group (A).

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

What is claimed is:

1. A chain extended polyurethane, polyurethaneurea and/or polyurea segmented copolymer comprising a polyol soft segment linked via a urethane or urea linkage to a hard segment having an amide segment, an ester segment or a combination of amide and ester segments as represented by Formula I
—R—B—(R′—B)ₙ—R— (I)
wherein each B represents an —N(H)C(O)—, —C(O)N(H)—, —C(O)—O— or —O—C(O)-moiety;
each R and R′ is a member selected from the group consisting of alkylene moieties, alicyclic moieties, arylene moieties, alkaryl moieties, arylalkyl moieties and heterocyclic moieties, and
n has a value of 0 to 6.

2. The copolymer of claim 1 wherein at least 50 percent of the —R—B—(R′—B)ₙ—R-segments are uniform in length as measured by NMR.

3. The copolymer of claim 1, wherein the segment —R—B—(R′—B)ₙ—R is a member selected from the group consisting of
—R—C(O)N(H)—R′—N(H)C(O)—R—
—R—N(H)C(O)—R′—C(O)N(H)—R—
—R—N(H)C(O)—R′—N(H)C(O)—R—
wherein each R and R′ is a member selected from the group consisting of alkylene moieties, alicyclic moieties, arylene moieties and heterocyclic moieties.

4. The copolymer of claim 1, wherein the segment —R—B—(R′—B)ₙ—R is a member selected from the group consisting of
—R—C(O)O—R′—OC(O)—R—
—R—OC(O)—R′—C(O)O—R—
—R—OC(O)—R′—OC(O)—R—
wherein each R and R′ is a member selected from the group consisting of alkylene moieties, alicyclic moieties, arylene moieties and heterocyclic moeities.

5. The copolymer of claim 3, wherein each R and R′ is a member selected from the group consisting of C1-C20 alkylene moieties, C4-C20 alicyclic moieties and C6-C20 arylene moieties.

6. The copolymer according to claim 5, wherein each R and R′ is a member selected from the group consisting of adipic acid residues, terephthalic acid residues, isophthalic acid residues and naphthalic acid residues.

7. The copolymer of claim 5, wherein each R and R′ is a member selected from the group consisting of C2-C8 alkylene moieties, C6-C12 arylene moieties and C6-C12 alicyclic moieties.

8. The copolymer of claim 1, wherein the urethane or urea group is based on isomers of toluene diamine, diphenylmethane diisocyanate, polymeric diphenylmethane diisocyanate, hexamethylene diisocyanate, p-phenylene diisocyanate, or 1,5-napthalene diisocyanate or mixtures thereof.

9. The copolymer of claim 1, wherein the polyol segment in the soft segment has a molecular weight in the range of 200-10,000 g/mol.

10. The polyol of claim 9, wherein polydispersity of the polyol is less than 1.2.

11. The polyol of claim 10, wherein the polyol has an unsaturation level of less than 0.015 meq unsaturation per gram of polyol.

12. The copolymer of claim 1, wherein the polyol segment is made of a hydroxyl or amine functionalized aliphatic, aromatic, or partially aromatic polymeric segment, wherein the polymeric segment includes a polyolefin, polyether, polyester, polycarbonate, polysiloxane, polysilane, or polyacrylate or copolymers thereof.

13. The copolymer according to claim 12, wherein the polyol segment includes a poly(tetramethylene oxide), poly(propylene oxide), polyethylene oxide), poly(tetramethylene adipate), polycarbonate, poly(ethylene/butylene), poly(dimethylsiloxane), polycarbonate or polyolefin and or copolymers thereof.

14. The copolymer of claim 1, wherein the glass transition temperature of the polymer is less than −30° C.

15. The copolymer of claim 1, wherein the melting temperature is at least 50° C.

16. The copolymer of claim 15, wherein the melting temperature of the polymer is at least 130° C.

17. The copolymer of claim 15, wherein the copolymer has an onset of crystallization of 50° C. or less below its peak melting temperature as measured in a differential scanning calorimeter at a scan rate of 20° C. per minute upon cooling from a melt of said polymer.

18. The copolymer of claim 15, wherein at least one of R is a C4 to C20 alicyclic or C6 to C20 arylene moiety with the proviso that such a moiety is not an amine-benzoic moiety.

19. An elastomer, fiber or extruded foam made from a copolymer of claim 1.

20. A method for producing a chain extended polyurethane, polyurethaneurea and/or polyurea segmented copolymer comprising reacting in a one-shot process a polyol, a polyisocyanate, and a chain-extender of the formula
X—R—B—(R′—B)_{n—R—X} (II)
wherein each B represents an —N(H)C(O)—, —C(O)N(H)—, —C(O)—O— or —O—C(O)-moiety;
each R and R′ is a member selected from the group consisting of alkylene moieties, alicyclic moieties, arylene moieties, alkaryl moieties, arylalkyl moieties or heterocyclic moieties;
n has a value of 0 to 6;
X is an isocyanate reactive group; and
the equivalent ratio of NCO groups on the isocyanate to active hydrogen groups on the polyol plus the chain extender is between 1:0.7 and 1:1:3, and the molar ratio of the chain extender to polyol is between 0.15:1 and 75:1.

21. A method for producing a chain extended polyurethane, polyuethaneurea and/or polyurea segmented copolymer comprising reacting an isocyanate-terminated prepolymer with a chain extender of the formula
X—R—B—(R′—B)ₙ—R—X (II)
wherein each B represents an —N(H)C(O)—, —C(O)N(H)—, —C(O)—O— or —O—C(O)-moiety;
each R and R′ is independently chosen from the group consisting of alkylene moieties, alicyclic moieties, arylene moieties, alkaryl or arylalkyl moieties or heterocyclic 20 moieties;
n has a value of 0 to 6;
X is an isocyanate reactive group; and
the isocyanate terminated prepolymer is the reaction product of a polyisocyanate and a polyol, where the equivalent ratio of NCO groups on the isocyanate to active hydrogen groups on the polyol plus the chain extender is between 1:0.7 and 1:1:3, and the molar ratio of the chain extender to polyol is between 0.15:1 and 75:1.

22. The method of claim 20, wherein n is 1, R includes an even number of atoms and includes fewer atoms than the R′, and X is an amine group.

23. The method of claim 21, wherein n is 1, R includes an even number of atoms and includes fewer atoms than the R′, and X is an amine group.

24. The method of claim 22, wherein R and R′ are each a member selected from for group consisting of di-methylene, 5 tetra-methylene, hexa-methylene, octa-methylene, dodeca-methylene, p-benze, 1,4-cyclohexyl, p-xylylene, and 1,5-naphthalene.

25. The method of claim 20, wherein n is 1, R includes an uneven number of atoms and includes fewer atoms than the R′, and X is a hydroxyl moiety.

26. The method of claim 21, wherein n is 1, R includes an uneven number of atoms and includes fewer atoms than R′, and X is a hydroxyl moiety.

27. The method of claim 24, wherein R and R′ are each members selected from the group consisting of tri-methylene, penta-methylene, hepta-methylene, m-benzene, 1,3-cyclohexyl, and m-xylylene moiety.

28. The chain extended polyurethane, polyurethaneurea and/or polyurea segmented copolymer according to claim 1, wherein n has a value of from 1 to 3.

29. The copolymer of claim 1, wherein at least 70 percent of the —R—B—(R′—B)ₙ—R—segments are uniform in length as measured by NMR.

30. The copolymer of claim 1, wherein the polyol segment in the soft segment has a molecular weight in the range of 300 to 7,000 g/mol.

31. The copolymer of claim 1, wherein the polyol segment in the soft segment has a molecular weight in the range of 400 to 5,000 g/mol.

32. The copolymer of claim 15, wherein the copolymer has an onset of crystallization of 50° C. or less below its peak melting temperature as measured in a differential scanning calorimeter at a scan rate of 40° C. per minute upon cooling from a melt of said polymer.

33. The copolymer of claim 15, wherein the copolymer has an onset of crystallization of 50° C. or less below its peak melting temperature as measured in a differential scanning calorimeter at a scan rate of 30° C. per minute upon cooling from a melt of said polymer.

34. The method according to claim 20, wherein the polyisocyanate is a diisocyanate.

35. The method according to claim 20, wherein n has a value of 0 to 3;

36. The method according to claim 20, wherein the isocyanate reactive group is a hydroxyl, primary amine or secondary amine.

37. The method according to claim 20, wherein the equivalent ratio of NCO groups on the isocyanate to active hydrogen groups on the polyol plus the chain extender is between 1:0.9 and 0.9:1.

38. The method according to claim 21, wherein n has a value of 0 to 3.

39. The method according to claim 21, wherein the isocyanate reactive group is a hydroxyl, primary amine or secondary amine.

40. The method according to claim 21, wherein the equivalent ratio of NCO groups on the isocyanate to active hydrogen groups on the polyol plus the chain extender is between 1:0.9 and 0.9:1.
